(19) United States
(12) Patent Application Publication
(10) Pub. No.: US 2023/0239435 A1
(43) Pub. Date: Jul. 27, 2023

(54) BODY-WORN CAMERA FOR VIRTUAL CONFERENCING

(71) Applicant: Carrier Corporation, Palm Beach Gardens, FL (US)

(72) Inventors: Subhash Reddy Gopavaram, Hyderabad (IN); Ramesh Lingala, Hyderabad (IN); Aswin Sukumaran Nair, Hyderabad (IN); Adam Cooper, Independence, OR (US); Mahesh Kodamati, Hyderabad (IN)

(21) Appl. No.: 18/159,425

(22) Filed: Jan. 25, 2023

Related U.S. Application Data
(60) Provisional application No. 63/303,546, filed on Jan. 27, 2022.

(51) Int. Cl. H04N 7/15; H04N 7/18; G07C 9/00

(52) U.S. Cl. CPC H04N 7/157; H04N 7/185; G07C 9/00309; G07C 9/00896; G07C 2009/00769

(57) ABSTRACT

A system and method for using a body-worn camera for virtual conferencing. A method includes connecting a wearable device to at least one of an electronic locking mechanism or a user device, and receiving a signal indicating the electronic locking mechanism is unlocked using a user device. The method can also include capturing video data to start a virtual session between the wearable device and a remote user device responsive to the signal indicating the electronic locking mechanism is unlocked, and transmitting video data to at least one user device or the remote user device.

### CROSS-REFERENCE TO RELATED APPLICATIONS

This application claims the benefit of U.S. Provisional Application No. 63/303,546 filed Jan. 27, 2022, all of which are incorporated herein by reference in their entirety.

### BACKGROUND

The present disclosure relates to virtual conferencing, and more specifically, to using body-worn cameras and virtual glasses for virtual conferencing.

Virtual conferences can help reduce or eliminate some of the cost and time required by travel to a central location to conduct a meeting. Video conferences may even have multiple participants that are geographically located in multiple locations. Although video conferencing may provide some of the benefits as face-to-face meetings, it is still limited in its ability to allow the same kinds of interactions that are permitted during an in-person conference. The systems and methods disclosed herein provide an improved approach for allowing remote participants to maintain an interactive session using virtualization technologies.

### BRIEF DESCRIPTION

According to an embodiment, a system for using a body-worn camera for virtual conferencing is provided. The system can include an electronic locking mechanism operable to control the lock based on a wireless signal; and a wearable device, wherein the wearable device comprises a video camera. The wearable device is configured to: connect to at least one of an electronic locking mechanism or a user device; receive a signal indicating the electronic locking mechanism is unlocked using a user device; capture video data to start a virtual session between the wearable device and a remote user device responsive to the signal indicating the electronic locking mechanism is unlocked; and transmit video data to at least one user device or the remote user device.

In addition to one or more of the features described herein, or as an alternative, further embodiments include a mobile user device that is operable to be connected to at least one of the wearable device or the electronic locking mechanism.

In addition to one or more of the features described herein, or as an alternative, further embodiments include using wearable device that is at least one of a body-worn camera or a virtual glasses technology.

In addition to one or more of the features described herein, or as an alternative, further embodiments include using a wearable device that is a smart watch comprising a microphone and a camera.

In addition to one or more of the features described herein, or as an alternative, further embodiments include using wearable device that is configured to automatically begin the virtual session responsive to receiving a signal from at least one of the mobile user device or the electronic locking mechanism.

In addition to one or more of the features described herein, or as an alternative, further embodiments include using a wearable device that is configured to capture and transmit video data in real-time.

In addition to one or more of the features described herein, or as an alternative, further embodiments include using an electronic locking mechanism that is configured to be operated based on a Bluetooth signal.

In addition to one or more of the features described herein, or as an alternative, further embodiments include authorizing a secondary user device to unlock the electronic locking mechanism.

In addition to one or more of the features described herein, or as an alternative, further embodiments include using a secondary user device that is configured to unlock the electronic locking mechanism and is further configured to provide a signal to the wearable device to initiate the virtual session.

In addition to one or more of the features described herein, or as an alternative, further embodiments include a server configured to store the virtual session.

According to another embodiment, a method for using a body-worn camera for virtual conferencing is provided. The method can include connecting a wearable device to at least one of an electronic locking mechanism or a user device; receiving a signal indicating the electronic locking mechanism is unlocked using a user device; capturing video data to start a virtual session between the wearable device and a remote user device responsive to the signal indicating the electronic locking mechanism is unlocked; and transmitting video data to at least one user device or the remote user device.

In addition to one or more of the features described herein, or as an alternative, further embodiments include connecting a mobile user device to at least one of the wearable device or the electronic locking mechanism.

In addition to one or more of the features described herein, or as an alternative, further embodiments include using a wearable device that is at least one of a body-worn camera or a virtual glasses technology.

In addition to one or more of the features described herein, or as an alternative, further embodiments include using a wearable device that is a smart watch comprising a microphone and a camera.

In addition to one or more of the features described herein, or as an alternative, further embodiments include automatically beginning the virtual session responsive to receiving a signal from at least one of the mobile user device or the electronic locking mechanism.

In addition to one or more of the features described herein, or as an alternative, further embodiments include a wearable device that is configured to capture and transmit video data in real-time.

In addition to one or more of the features described herein, or as an alternative, further embodiments include an electronic locking mechanism that is configured to be operated based on a Bluetooth signal.

In addition to one or more of the features described herein, or as an alternative, further embodiments include authorizing a secondary user device to unlock the electronic locking mechanism.

In addition to one or more of the features described herein, or as an alternative, further embodiments include using a secondary user device that is configured to unlock the electronic locking mechanism and is further configured to provide a signal to the wearable device to initiate the virtual session.

In addition to one or more of the features described herein, or as an alternative, further embodiments include storing the virtual session in a server.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 depicts an exemplary system used for implementing a virtual conference in accordance with one or more embodiments of the disclosure;

FIG. 2 depicts an exemplary wearable device used for a virtual conference in accordance with one or more embodiments of the disclosure; and

FIG. 3 depicts a flowchart of a method for implementing a virtual conference using the wearable device in accordance with one or more embodiments of the disclosure.

### DETAILED DESCRIPTION

Virtual tours allow users that are geographically remote from one another to attend a virtual session. Additionally, the virtual tour may be recorded and replayed at a later time for convenience. Also, virtually hosted tours can enable a plurality of users to attend the session without regard to the physical limitations of the property for the virtual tour.

The agent's camera or mobile phone used for the virtual tour may not have sufficient power during the time of the virtual tour which can be inconvenient for the participants. In such a scenario, the agent may need to plug in the camera or phone to wall power which can limit the agent's ability to move freely throughout the property. Therefore, there may be a need for additional conferencing technologies to assist the virtual tour.

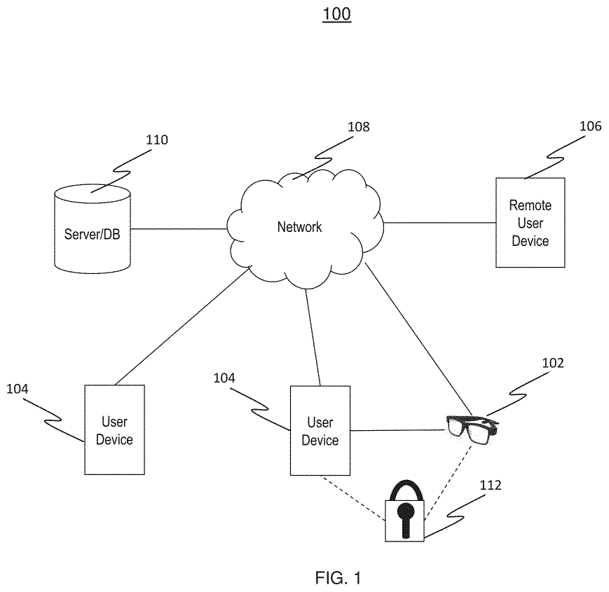

FIG. 1 depicts a system 100 that can include a wearable device 102 and user device(s) 104. In some embodiments of the disclosure, user device 104 is a laptop computer, a tablet computer, a netbook computer, a personal computer (PC), a desktop computer, a personal digital assistant (PDA), a smartphone, a smart watch, an internet-of-things (IoT) enabled device, an IoT enable Virtual Reality (VR)/Augmented Realty (AR) space, and/or other suitable programmable electronic devices capable of communicating with various components and devices within the distributed system environment.

The wearable device 102 can be worn by a user which can allow the user free access to their hands to perform other tasks. The wearable device 102 can also be configured to communicate over a wireless connection such as a Wi-Fi or Bluetooth connection. The wearable device 102 can include an integrated video camera and microphone that is configured to obtain video data and audio data, respectively. The video data captured from the wearable device 102 can be transmitted to a remote user device 106 through a user device 104 that is coupled to the wearable device 102 and/or through a network 108 to allow a remote user to view the live video feed in real-time.

The network(s) 108 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof. In one or more embodiments of the disclosure, the wearable device 102 and or the user device 104 can transmit the video data over the network 108 and store the video data in the server 110. The sharing of the real-time video data can help facilitate an interactive process such as a real-estate property showing between a buyer/seller and their real-estate agent. The remote buyer and/or seller can view the video feed obtained by the real-estate agent.

In one or more embodiments of the disclosure, an electronic locking mechanism 112 can be used to lock a property that may be made accessible to multiple people. Oftentimes, in real estate property showings multiple real estate agents can get authorization to access a specific property and credentials to unlock the electronic locking mechanisms can be provided to the user device 104 of the real estate agent. The user device 104, such as a mobile phone, can provide a wireless signal, such as a short-range Bluetooth signal, to unlock the electronic locking mechanism 112 if the credentials are valid. In a different scenario where the agent is unavailable, the agent or an authorized party may transfer the certificate to a secondary user/user device that is trusted by the agent, which allows the secondary user device to initiate the start of the virtual session. To increase security, the agent can limit the user's access to a specific time slot. Responsive to unlocking the electronic locking mechanism, additional devices can be searched by the lock box for connection over the wireless connection, e.g., Bluetooth connection.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

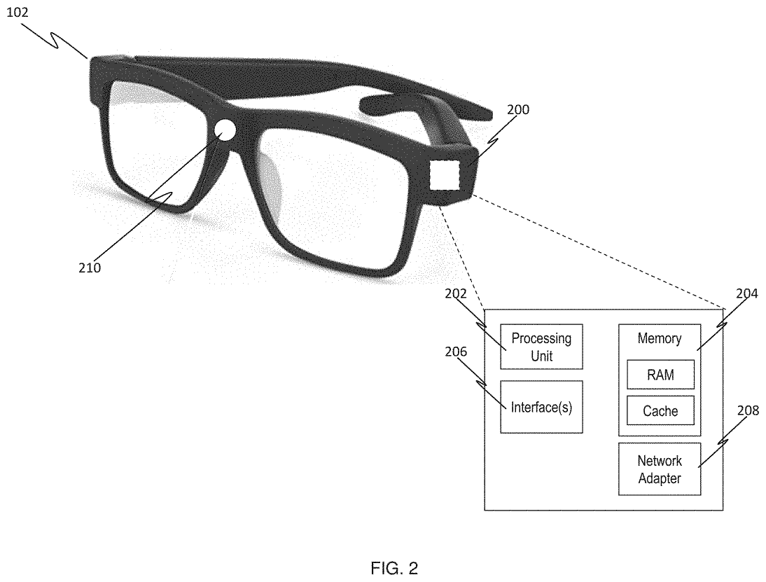

Referring now to FIG. 2, a further detailed view for an exemplary wearable device 102 in accordance with one or more embodiments of the present disclosure is shown. The wearable device 102 is shown including a processor 200. The components of processor 200 may include, but are not limited to, one or more processors 202, a memory 204, interface 206, and network adapter 208. In one or more embodiments of the disclosure, the processing unit 202 can include a processing unit 202 of a general-purpose computer, special purpose computer, or other programmable data processing apparatus configured to execute instruction via the processor of the computer or other programmable data processing apparatus.

Processer 200 can include a variety of computer system readable media. Such media may be any available media that is accessible by processer 200, and it includes both volatile and non-volatile media, removable and non-removable media. Memory 204 can include computer system readable media. The memory 204 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), etc.). Processer 200 may further include other removable/non-removable, volatile/non-volatile computer system storage media. The processing unit 202 and a memory 204 are configured to carry out the operations for the nodes.

The memory 204 may include one or more program modules (not shown) such as operating system(s), one or more application programs, other program modules, and program data. Each of the operating systems, one or more application programs, other program modules, and program data or some combination thereof, may include an implementation of a networking environment. The program modules generally carry out the functions and/or methodologies of embodiments of the invention as described herein.

Processer 200 may also communicate with one or more external devices through the interface 206 such as a keyboard, a pointing device, a display, etc.; one or more devices that enable a user to interact with processer 200; and/or any devices (e.g., network card, modem, etc.) that enable processer 200 to communicate with one or more other computing devices.

Still yet, processer 200 can communicate with one or more networks such as a local area network (LAN), a general wide area network (WAN), and/or a public network (e.g., the Internet) via network adapter 208. As depicted, network adapter 208 communicates with the other components of processer 200. It should be understood that although not shown, other hardware and/or software components could be used in conjunction with processer 200. Also, FIG. 2 includes a video camera 210 that is operably coupled to the processer 200 to capture and transmit video data.

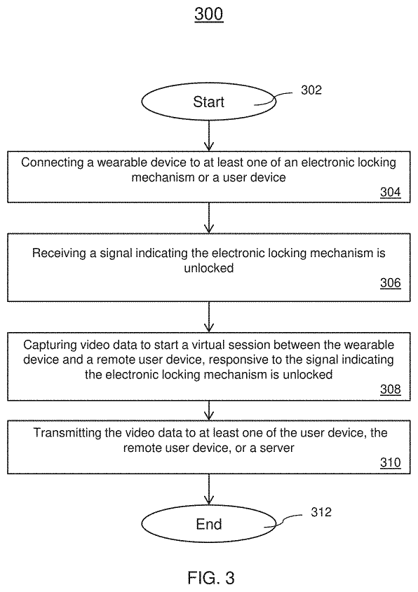

FIG. 3 depicts a method 300 for implementing a wearable camera device in accordance with one or more embodiments of the disclosure. The method 300 can be implemented in the system such as that shown in FIGS. 1 and 2. However, it can be appreciated FIGS. 1 and 2 are not intended to limit the scope of the disclosure. The method 300 begins at block 302 and proceeds to block 304 where a wearable device is connected to at least one of an electronic locking mechanism or a user device.

At block 306, a wearable device receives a signal indicating the electronic locking mechanism is unlocked using a user device. The electronic locking mechanism is configured to be operated based on a Bluetooth signal from a user device or other connected devices. The unlock signal can be received either from the user device have the appropriate credentials to unlock the electronic locking mechanism or the unlock signal can be received directly from the electronic locking mechanism. In a non-limiting example, a user can authorize a secondary user device to unlock the electronic locking mechanism by transferring the appropriate credentials to the secondary user device. The secondary user device is configured to unlock the electronic locking mechanism by transmitting a wireless signal to the electronic locking mechanism and is further configured to provide a signal to the wearable device to initiate the virtual session.

At block 308, the wearable device captures video data to start a virtual session between the wearable device and a remote user device, responsive to the signal indicating the electronic locking mechanism is unlocked. In one or more embodiments of the disclosure, the wearable device may include virtual glasses, smart watches, or body-worn cameras which can automatically begin recording the session responsive to receiving a signal indicating the electronic locking mechanism has been unlocked. The wearable device is configured to capture and transmit video data in real-time. In another embodiment, a server can receive the transmitted video data and store the virtual session.

At block 310, the wearable device transmits the video data to at least one of the user device, the remote user device, or a server. The method 300 ends at block 312. The process flow diagram of FIG. 3 is not intended to indicate that the operations of the method 300 are to be executed in any particular order, or that all of the operations of the method 300 are to be included in every case. Additionally, the method 300 can include any suitable number of additional operations.

The technical effects and benefits include facilitating additional means for virtual tours. Such scenarios may include facilitating a real estate property tour between an agent and a client. Other scenarios may include providing remote assistance to a technician and a remote technician that may be onsite especially when the technicians require both hands to be free and are unable to hold a camera. Further the technical effects and benefits include aiding live interactions between parties that are geographically separated.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system for using a body-worn camera for virtual conferencing, the system comprising:
an electronic locking mechanism operable to control the lock based on a wireless signal;
a wearable device, wherein the wearable device comprises a video camera and is configured to:
connect to at least one of an electronic locking mechanism or a user device;
receive a signal indicating the electronic locking mechanism is unlocked using a user device;
capture video data to start a virtual session between the wearable device and a remote user device responsive to the signal indicating the electronic locking mechanism is unlocked; and
transmit video data to at least one user device or the remote user device.

2. The system of claim 1, further comprising a mobile user device that is operable to be connected to at least one of the wearable device or the electronic locking mechanism.

3. The system of claim 1, wherein the wearable device is at least one of a body-worn camera or a virtual glasses technology.

4. The system of claim 1, wherein the wearable device is a smart watch comprising a microphone and a camera.

5. The system of claim 1, wherein the wearable device is configured to automatically begin the virtual session responsive to receiving a signal from at least one of the mobile user device or the electronic locking mechanism.

6. The system of claim 1, wherein the wearable device is configured to capture and transmit video data in real-time.

7. The system of claim 1, wherein the electronic locking mechanism is configured to be operated based on a Bluetooth signal.

8. The system of claim 1, further comprising authorizing a secondary user device to unlock the electronic locking mechanism.

9. The system of claim 8, wherein the secondary user device is configured to unlock the electronic locking mechanism and is further configured to provide a signal to the wearable device to initiate the virtual session.

10. The system of claim 1, further comprising a server to store the virtual session.

11. A method for using a body-worn camera for virtual conferencing, the method comprising:
connecting a wearable device to at least one of an electronic locking mechanism or a user device;
receiving a signal indicating the electronic locking mechanism is unlocked using a user device;
capturing video data to start a virtual session between the wearable device and a remote user device responsive to the signal indicating the electronic locking mechanism is unlocked; and
transmitting video data to at least one user device or the remote user device.

12. The method of claim 11, further comprising connecting a mobile user device to at least one of the wearable device or the electronic locking mechanism.

13. The method of claim 11, wherein the wearable device is at least one of a body-worn camera or a virtual glasses technology.

14. The method of claim 11, wherein the wearable device is a smart watch comprising a microphone and a camera.

15. The method of claim 11, further comprising automatically beginning the virtual session responsive to receiving a signal from at least one of the mobile user device or the electronic locking mechanism.

16. The method of claim 11, wherein the wearable device is configured to capture and transmit video data in real-time.

17. The method of claim 11, wherein the electronic locking mechanism is configured to be operated based on a Bluetooth signal.

18. The method of claim 11, further comprising authorizing a secondary user device to unlock the electronic locking mechanism.

19. The method of claim 18, wherein the secondary user device is configured to unlock the electronic locking mechanism and is further configured to provide a signal to the wearable device to initiate the virtual session.

20. The method of claim 11, further comprising storing the virtual session in a server.
